(19) United States
(12) Patent Application Publication
(10) Pub. No.: US 2006/0085206 A1
(43) Pub. Date: Apr. 20, 2006

(54) System and method for a controller to define, determine, and execute cross-application processes

(76) Inventors: Timo Seufert, Speyer (DE); Winfried Schwarzmann, Rauenberg (DE); Amar Kumar, Neulussheim (DE)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/962,013

(22) Filed: Oct. 8, 2004

(51) Int. Cl. G06Q 99/00

(52) U.S. Cl. 705/1

(57) ABSTRACT

Embodiments of the invention are generally directed to providing flexible process configurations for software systems and to the execution of those software systems. In one embodiment, a user may use a cross-application process controller to select and arrange the methods that constitute a software system. In an embodiment, the cross-application process controller receives input and executes the selected methods based, at least in part, on the received input.

### TECHNICAL FIELD

Embodiments of the invention generally relate to the field of data processing and, more particularly, to a system and method for a controller to define, determine, and execute cross-application processes.

### BACKGROUND

In the past, enterprises were willing to reorganize their business processes to fit them into the relatively static structures of business software systems. More recently, however, enterprises have been more reluctant to reorganize their business processes for reasons such as the expense incurred by the reorganization. In addition, many enterprises are interested in retaining (rather than changing) business processes that have proved to be successful.

A conventional approach to providing more flexible business software systems involves the configuration of system process flows with parameters. The individual values of these parameters are set during customization of the software and respected by the processes during runtime. The configuration of process flows via parameters, however, is encumbered by a number of limitations. For example, the way in which certain parameter values influence the process flow within the system is not always clear to a user. This limitation can be partly addressed through thorough documentation and/or the expertise provided by consultants. Either of these partial solutions, however, increases the costs of the software implementation.

A second limitation of the conventional approach is that the complexity of the coding of business software increases disproportionately with the number of parameters. The increase in the complexity of the coding leads to a greater possibility of coding faults, especially for unusual parameter value combinations. This complexity and the resulting maintenance and support challenges cause functional extensions of the software to be developed more slowly or not at all.

### SUMMARY OF THE INVENTION

Embodiments of the invention are generally directed to providing flexible process configurations for software systems and to the execution of those flexible process configurations. In one embodiment, a user may use a cross-application process controller to select and arrange the methods that constitute a software system. In an embodiment, the cross-application process controller receives input and executes the selected methods based, at least in part, on the received input.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is a block diagram of selected elements of a cross-application process controller, according to an embodiment of the invention.

FIG. 2 is a block diagram illustrating a data-oriented view of a service controller, according to an embodiment of the invention.

FIG. 3 is a block diagram showing additional details of a data-oriented view of a service controller, according to an embodiment of the invention.

FIG. 4 is a block diagram illustrating selected aspects of a graphical user interface to define a strategy according to an embodiment of the invention.

FIG. 5 is a block diagram illustrating the determination of a strategy, according to an embodiment of the invention.

FIG. 6 is a block diagram illustrating the addition of a new method to a method pool, according to an embodiment of the invention.

FIG. 7 is a block diagram illustrating a method data handling infrastructure, according to an embodiment of the invention.

FIG. 8 is a block diagram illustrating a class-oriented view of a service controller, according to an embodiment of the invention.

FIGS. 9A-9B are flow diagrams illustrating certain aspects of a process for a service controller, according to an embodiment of the invention.

FIG. 10 is a block diagram illustrating various interfaces according to an embodiment of the invention.

### DETAILED DESCRIPTION

Embodiments of the invention are generally directed to providing flexible process configurations for software systems and to the execution of those flexible process configurations. In one embodiment, a user may use a cross-application process controller to select and arrange the methods that constitute a software system. In an embodiment, the cross-application process controller receives input and executes the selected methods based, at least in part, on the received input.

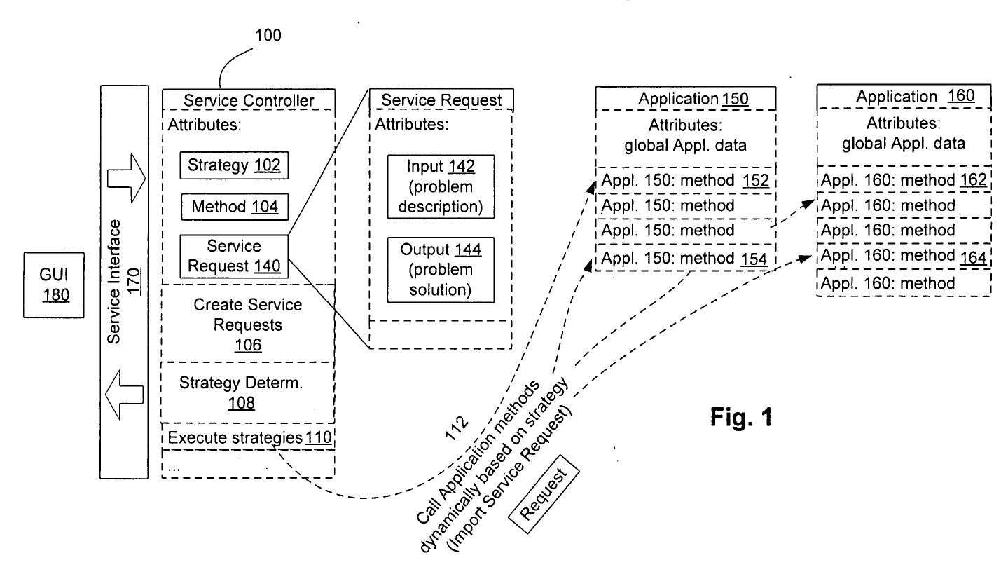

FIG. 1 is a block diagram of selected elements of cross-application process controller 100, according to an embodiment of the invention. In an embodiment, cross-application process controller 100 may be part of a multi-tiered network. The multi-tiered network may be implemented using a variety of different application technologies at each of the layers of the multi-tier architecture, including those based on the Java 2 Enterprise Edition™ (“J2EE”) specification (e.g., the Websphere platform developed by IBM Corporation), the Microsoft NET platform, and/or the Advanced Business Application Programming (“ABAP”) platform developed by SAP AG. The J2EE specification refers to any of the J2EE specifications including, for example, the Java 2 Enterprise Edition Specification v1.3, published on Jul. 27, 2001.

The illustrated embodiment of cross-application process controller 100 includes strategy 102, method(s) 104, service request 140, strategy determination logic 108, and strategy execution logic 110. In an alternative embodiment, cross-application process controller 100 may have more elements, fewer elements, and/or different elements. In an embodiment, cross-application process controller 100 (or, for ease of reference, service controller 100) provides a framework which allows the definition of various software services. These services may be based, at least in part, on a strategy 102 that is defined for each service request 140. Alternatively, service controller 100 may use strategy determination logic 108 to determine a strategy (e.g., strategy 102) for a given request (e.g., service request 140). As is further described below, service controller 100 also provides a framework to execute strategy 102.

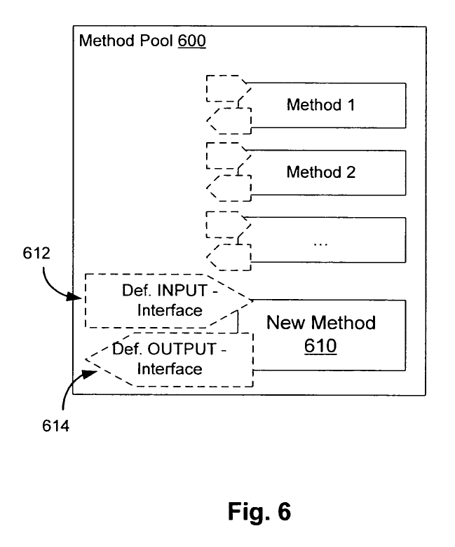

Method 104 provides a logical processing element for a cross-application process. Method 104 may provide new functionality (e.g., a new method) or may encapsulate existing functionality from various applications. Each method 104 is designed to be as technically independent as possible to enhance the flexibility of strategy 102. In some cases, however, method 104 may share a fixed relationship with one or more other methods. For example method 104 may share coding with one or more other methods. As is further described below with reference to FIG. 6, each method 104 shares the same interface. In an embodiment, a method pool (not shown) encompasses all of the methods which may be used to define strategy 102.

Graphical User Interface (GUI) 180 provides an interface to service controller 100. In one embodiment, GUI 180 is a stand-alone GUI. The term “stand-alone” refers to a GUI that functions independently of a Web browser. GUI 180 may provide access to a service specific layer of service controller 100.

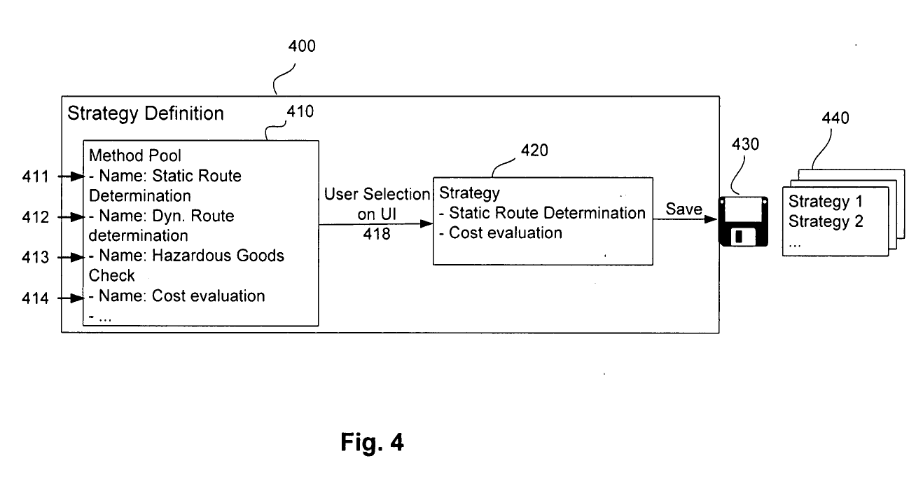

Strategy 102 groups one or more methods (e.g., method(s) 104) from the method pool. In an embodiment, strategy 102 determines the order in which the grouped methods are executed. This order may be constrained, in part, by the relationships, if any, among the methods. For example, if two methods are selected for strategy 102 and they share a predecessor/successor relationship, then that relationship may partly determine the ordering of those two methods. In addition, the predecessor/successor relationship may determine that strategy 102 should include both methods to be valid. Defining strategy 102 is further described below with reference to FIG. 4.

In an embodiment, service request 140 is an object that represents demands placed on the implemented service. For example, the illustrated embodiment of service request 140 includes input 142 and output 144. Input 142 provides fields and/or methods describing, for example, a business problem to be solved by the implemented service. Output 144 provides fields and/or methods describing a solution to the problem. Service controller 100 constructs service request 140 and processes it. In an embodiment, processing service request 140 includes passing it to the methods of strategy 102. In an embodiment, create service requests logic 106 generates service request 140.

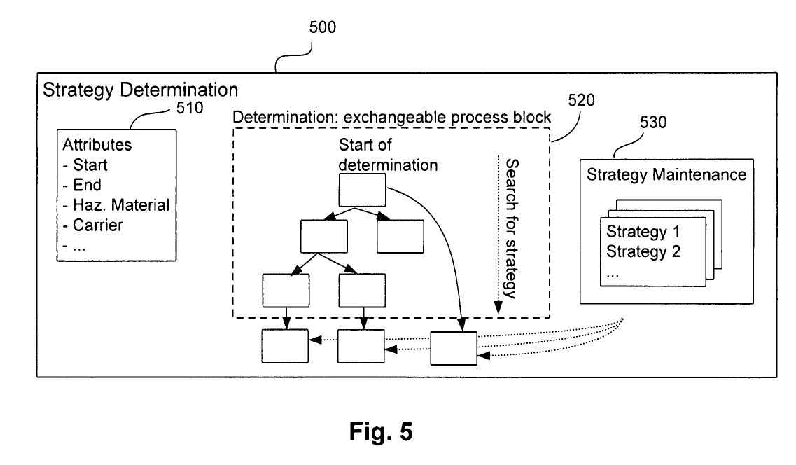

In an embodiment, each service request 140 is associated with a strategy 102. The association may be explicitly determined by input received through service interface 170. Alternatively, service controller 100 may use strategy determination logic 108 to select a strategy for service request 140. Strategy determination is further described below with reference to FIG. 5.

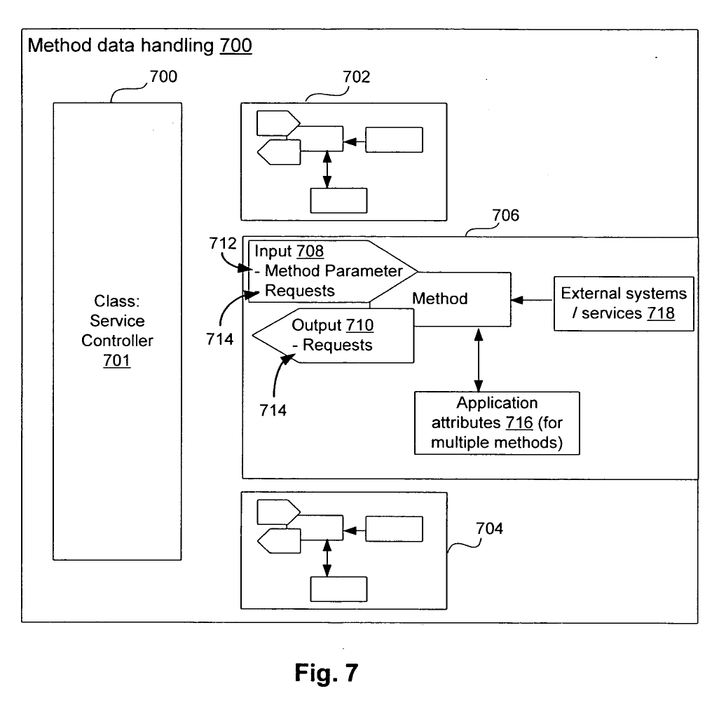

Application classes 150 and 160 provide the methods for the method pool. Each of the methods in the method pool is associated with an application class (e.g., application class 150 and 160). In an embodiment, each method may store data that it produces in its associated application class (with reference to FIG. 7). Other methods of the application class may access the data that the method stores in the application class. In addition, service controller 100 may access data stored in the application class to enhance a result before passing the result through service interface 170.

Strategy execution logic 110 provides logic to execute the methods of a strategy (e.g., strategy 102). In an embodiment, strategy execution logic 110 dynamically calls the methods of strategy 102 as shown by 112. Strategy execution logic 110 may pass service request 140 to each method of strategy 102 in the order defined by strategy 102. For example, strategy 102 may dictate that strategy execution logic 110 execute methods 152, 154, 162, and 164 and may further dictate that they are executed in that order. Strategy execution logic 110 may pass service request 140 to each of methods 152, 154, 162, and 164, as it dynamically calls the methods.

Service interface 170 is an input/output interface. In an embodiment, service interface 170 is a service-specific interface. The term “service-specific” refers to an implementation that is specific to a particular cross-application process.

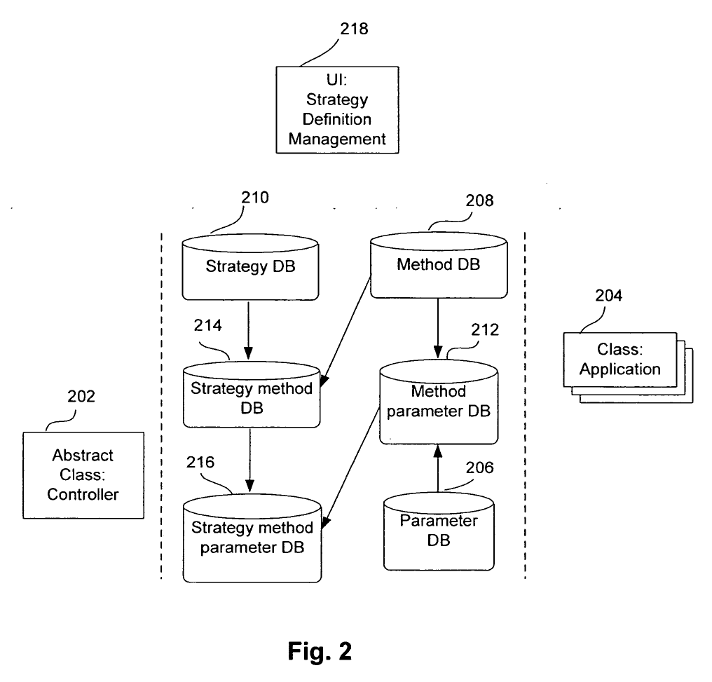

FIG. 2 is a block diagram illustrating a data-oriented view of a service controller, according to an embodiment of the invention. In an embodiment, a service controller includes a framework to define and organize parameters, methods, and strategies to create a service-specific instance of a service controller based on one or more classes (e.g., abstract controller class 202 and application class 204).

In one embodiment, a service controller includes parameter database 206. Parameter database 206 provides a source of information with which the service controller can define parameters in a logical way. This information includes parameter types that define the syntactic and semantic properties of operational parameters. The parameter types may be, generally, available to the methods of the service provider. For example, the methods executed in the service controller may use parameters that are defined in parameter database 206.

In one embodiment, the service controller includes method database 208. Method database 208 provides a source of information with which the service controller can define methods in a logical way. This information includes method types that define the syntactic and semantic properties of operational methods. The method types may be, generally, available to the strategies of the service provider. For example, the methods executed in the service controller may be defined in method database 208.

In one embodiment, the service controller includes strategy database 210. Strategy database 210 provides a source of information with which the service controller can define strategies in a logical way. This information includes strategy types that define the syntactic and semantic properties of operational strategies. The strategy types may be, generally, available to the service provider. For example, the strategies executed in the service controller may be defined in strategy database 210.

In an embodiment, method parameter database 212 includes method parameters based on parameter types from parameter database 206 that work with methods based on method types from method database 208. Similarly, strategy method database 214 includes methods that are based on the method types of method database 208. Default values may be assigned to a combination of the method parameters of method parameter database 212 and the strategy methods of strategy method database 214 in strategy method parameter database 216. In an embodiment, application class 204 includes one or more methods available to one or more strategies.

User interface 218 is an interface that allows a user to maintain (and/or define) the data of the various databases shown in FIG. 2. For example, a user may define parameters based on the parameter types of parameter database 206. Similarly, the user may define methods based on the method types of method database 208. In addition, the user may define one or more strategies using user interface 218. In an embodiment, a service controller accesses the various databases to store (and retrieve) its attributes. For example, the service controller may store strategies, methods, requests, and the like in one or more databases.

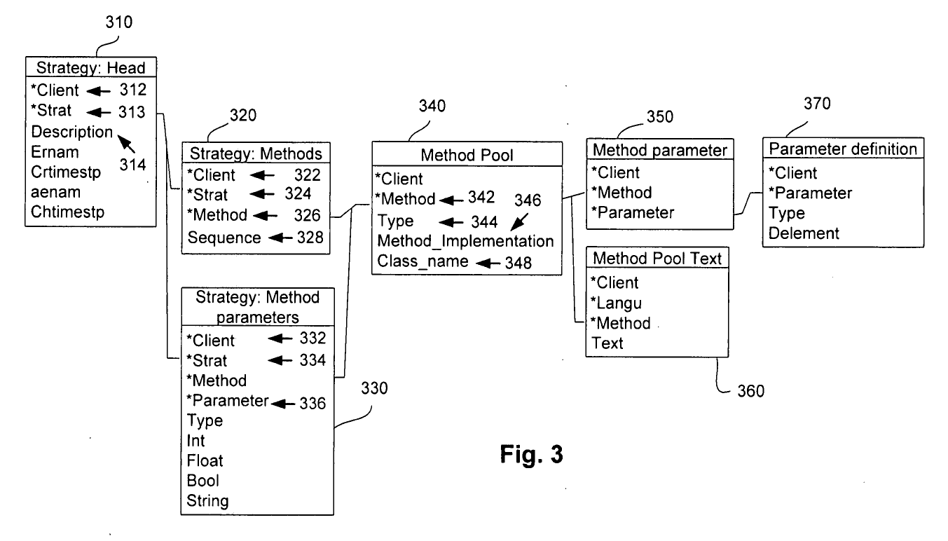

FIG. 3 is a block diagram showing additional details of a data-oriented view of a service controller, according to an embodiment of the invention. The illustrated data-oriented view includes strategy 310. Strategy 310 includes metadata such as a client identifier 312, a table key 313, and a description 314. Methods 320 and method parameters 330 refer to strategy 310 using, for example, key 313. Methods 320 and method parameters 330 each include client and strategy identifiers as shown by 322-324 and 332-334. Method 320 also includes one or more methods 326 and sequence 328 to specify a sequence for the methods. Method parameters 330 includes method parameters 336 for use in methods 320 as default parameters.

Methods 320 are drawn from method pool 340. In an embodiment, for each method 342, method pool 340 includes information such as type 344, implementation 346, and/or class name 348 (e.g., the information to support a dynamic call). Method parameter 350 is a parameter of a method in method pool 340 and is based on parameter definition 370. Method pool text 360 provides text (e.g., method descriptions, method names, etc.) for one or more methods of method pool 340.

FIG. 4 is a block diagram illustrating selected aspects of a graphical user interface (GUI) 400, according to an embodiment of the invention. In one embodiment, GUI 400 provides an interface to define a strategy. GUI 400 includes, for example, method pool 410 and strategy 420. Method pool 410, in turn, includes methods 411-414. Methods 411-414 may be provided by a vendor or defined by a customer. As shown in FIG. 4, in one embodiment, GUI 400 displays a name and a description for each of the one or more methods in method pool 410. In an embodiment, methods 411-414 are selectable via a cursor control device. The term “cursor control device” broadly refers to an input/output device that moves a cursor within a graphical user interface. Examples of a cursor control device include (and are not limited to) a pointing device and/or a keyboard.

In one embodiment, method pool 410 is displayed in a first window of GUI 400 and strategy 420 is displayed in a second window of GUI 400. In an alternative embodiment, method pool 410 and strategy 420 may be displayed (or partly displayed) in more windows and/or fewer windows of GUI 400. The term “window” refers to a scrollable viewing area on a screen.

In an embodiment, a user selects one or more methods from method pool 410 for inclusion in strategy 420. For example, the user may drag and drop a method from method pool 410 to strategy 420. Alternatively, the user may provide another indication to assign a method to strategy 420 such as right clicking on the method, left clicking on the method, and the like. In addition, the user may arrange the selected methods in a particular order or otherwise specify a sequence in which the methods are to be executed. Strategy 420 is stored in memory 440 which may be, for example, one or more hard disks, floppy disks, ZIP disks, compact disks (e.g., CD-ROM), digital versatile/video disks (DVD), magnetic random access memory (MRAM) devices, and other system-readable media that store instructions and/or data. In an embodiment, one or several strategies may be stored in memory 430 as shown by 440.

In one embodiment, the validity of strategy 420 is checked before saving it to memory 440. For example, validity logic may determine whether any method of strategy 420 shares a predecessor/successor relationship with another method. If a method of strategy 420 does share a predecessor/successor relationship with another method, the validity logic may ensure that the sequence of the methods of strategy 420 does not conflict with the relationship. The validity logic may also ensure that strategy 420 includes all of the methods that are part of the relationship.

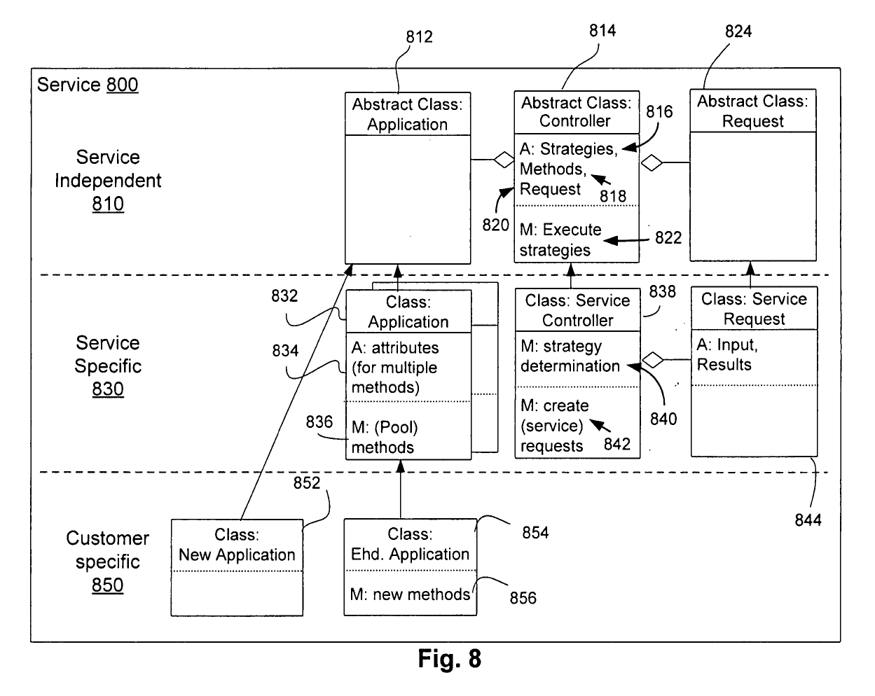

FIG. 5 is a conceptual illustration of determining a strategy according to an embodiment of the invention. Strategy determination process 500 includes attributes 510, determination logic 520, and strategy maintenance logic 530. Attributes 510 are provided by a user through, for example, a service interface (e.g., service interface 170, shown in FIG. 1). Attributes 510 specify the attributes of a business problem that is to be solved by the service controller. For example, in the illustrated embodiment, attributes 510 are the attributes of a routing problem and include the start of the route, the end of the route, the transportation service provider, etc. Strategy determination logic 520, which is defined on the service specific level (e.g., service specific level 830, shown in FIG. 8) as part of the service controller (e.g., service controller 100, shown in FIG. 1), determines which of the previously defined strategies in strategy maintenance logic 530 should be applied to attributes 510. In one embodiment, strategy determination logic 520 determines the appropriate strategy based, at least in part, on an exchangeable process block algorithm. In an alternative embodiment, strategy determination logic 520 may include an additional algorithm and/or a different algorithm.

In an embodiment, a user may provide new functionality to the strategies of a service controller by defining a new method and adding it to a method pool. FIG. 6 is a conceptual diagram illustrating the addition of a new method to method pool 600, according to an embodiment of the invention. In an embodiment, the user may create a new method based on a method type from a method database, (e.g., method database 208, shown in FIG. 2) via a GUI (e.g., strategy definition management introduced in FIG. 2) or other user interface. New method 610 may then be added to method pool 600 using the GUI. In an embodiment, each method shares a common interface. For example, new method 610 includes input interface 612 and output interface 614. Interfaces 612-614 are further described below with reference to FIG. 7.

FIG. 7 is a block diagram illustrating method data handling infrastructure 700 according to an embodiment of the invention. Service controller 701 includes methods 702-706. In one embodiment, all of the methods of service controller 701 implement the same interface. In such an embodiment, the methods can be anonymously executed. The term “anonymously executed” indicates that the service controller calls the methods without knowing which methods are actually invoked. An example of this interface is described with reference to method 706 but it is to be appreciated that methods 702-704 implement a similar interface. In an embodiment, the interface includes input structure 708 and output structure 710. Input structure 708 receives method parameter(s) 712 and request 714 from, for example, strategy execution logic (e.g., strategy execution logic 110, shown in FIG. 1). Method parameter(s) 712 includes one or more method parameters that define a problem for a software process. In one embodiment, a user provides parameters 712 to service controller 701 via a service interface (e.g., service interface 170, shown in FIG. 1).

In an embodiment, request 714 includes both a data object describing the problem and a data object for storing solutions to the problem. In one embodiment, a strategy of service controller 701 passes method parameter(s) 712 and requests 714 to method 706. Method 706 processes requests 714 based, at least in part, on parameters 712 and returns requests 714 to service controller 701 through output structure 710. Service controller 700 has access to the data of method 706 and determines whether to pass the data back through the service interface.

As described above, service controller 701 includes one or more application classes (e.g., application classes 150 and 160) to provide methods for the service controller. Each method is associated with a particular application class. The data that method 706 produces may be stored in its associated application class instance. In addition, the associated application class may have one or more application attributes 716 that define global application data. In an embodiment, the behavior of method 706 is based, partly, on application attributes 716.

In one embodiment, method 706 accesses external systems and/or services 718 to obtain data. The behavior of method 706 may also be based, partly, on the data obtained from external systems and/or services 718. For example, method 706 may access external systems and/or services 718 to calculate a cost and then process request 714 based, partly, on the result of the cost calculation.

FIG. 8 is a block diagram illustrating a class-oriented view of a service 800, according to an embodiment of the invention. Service 800 includes service independent layer 810, service specific layer 830, and customer specific layer 850. In general, the classes in each successive layer are derived from the classes in the proceeding layer. Thus, in an embodiment, service 800 may have a predecessor layer (e.g., service independent layer 810) but not yet have a succeeding layer (e.g., service specific layer 830).

Service independent layer 810 includes abstract application class 812, abstract controller class 814, and abstract request class 824. An abstract class is a superclass in which not all class members are implemented. Consequently, it cannot have any objects. But references to objects of non-abstract subclasses may be used in order to implement functionality (e.g., to implement some of its methods). In addition, like other superclasses, it provides class members (e.g., fields and/or methods) for one or more subclasses. In the illustrated embodiment, abstract application class 812 includes one or more abstract application fields and/or methods. Similarly, abstract request class 824 includes one or more abstract request fields and/or methods.

Abstract controller class 814 provides an abstract class upon which concrete controller subclasses may be based. The class members of abstract controller class 814 may be based, at least in part, on abstract application class 812 and abstract request class 824. For example, strategies 816, methods 818, and requests 820 of abstract controller class 814 may be based, at least in part, on the members of abstract classes 812 and 824.

Service specific layer 830 includes classes that may be instantiated to provide functionality for a specific service (e.g., a routing service in a transportation management program). For example, application class 832 may be a concrete class derived from abstract application class 812. Similarly, service controller class 838 may be a concrete class derived from abstract controller class 814.

Application class 832 includes one or more attributes 834 that define global application data for the methods 836. Strategy determination logic 840 includes service specific strategy determination logic for service controller 838. Similarly, method 842 provides logic to create requests for service controller class 838. Request class 844 provides logic to define requests including, for example, input components and output components of the request.

The flexible framework of service 800 enables a customer to extend the functionality of the controller. Customer specific layer 850, for example, includes new application class 852 and enhanced application class 854. New application class 852 is a new application class derived from abstract application class 812. Enhanced application class 854 is a customer specific class that includes new method(s) 856.

In an alternative embodiment, service 800 is not (or, at least, is not completely) based on object-oriented classes and methods. For example, in an embodiment, service 800 is based (or is partly based) on an interpretable programming language such as ABAP. In such an embodiment, anonymous method execution is supported by features such as dynamic function calling.

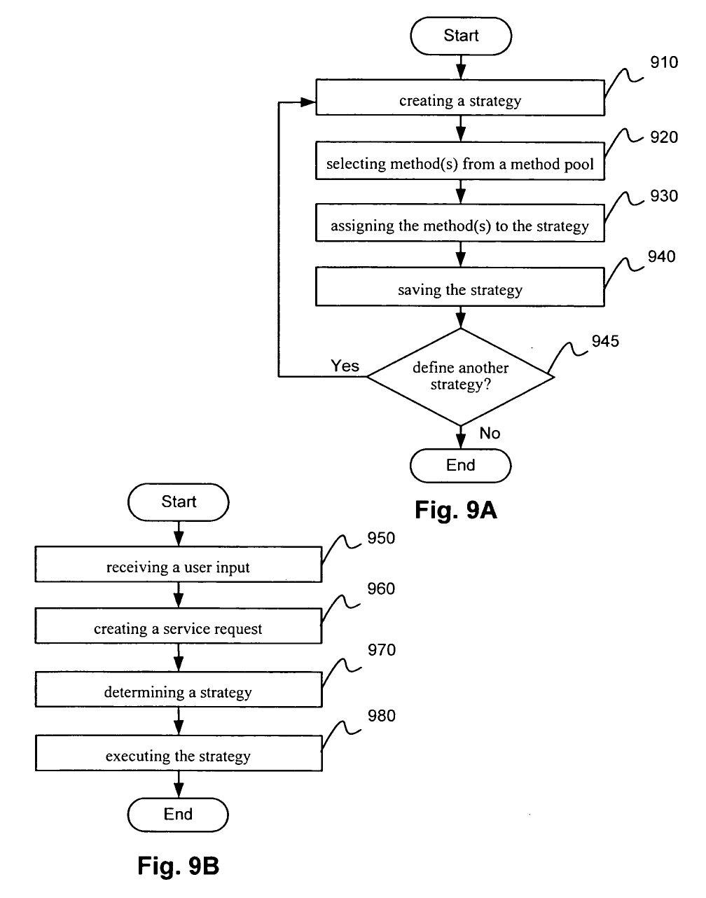

Turning now to FIGS. 9A-9B, the particular methods associated with embodiments of the invention are described in terms of computer software and hardware with reference to a flowchart. The methods to be performed by a computing device (e.g., an application server) may constitute state machines or computer programs made up of computer-executable instructions. The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement embodiments of the invention as described herein. Furthermore, it is common in the art to speak of software, in one form or another (e.g., program, procedure, process, application, etc.), as taking an action or causing a result. Such expressions are merely a shorthand way of saying that execution of the software by a computing device causes the device to perform an action or produce a result.

FIG. 9A is a flow diagram illustrating certain aspects of a process for defining a strategy, according to an embodiment of the invention. Referring to process block 910, a strategy is created. In an embodiment, creating a strategy refers to creating a logical structure for a strategy (e.g., strategy 310, shown in FIG. 3) using, for example, strategy definition management logic (e.g., strategy definition management logic 400, shown in FIG. 4).

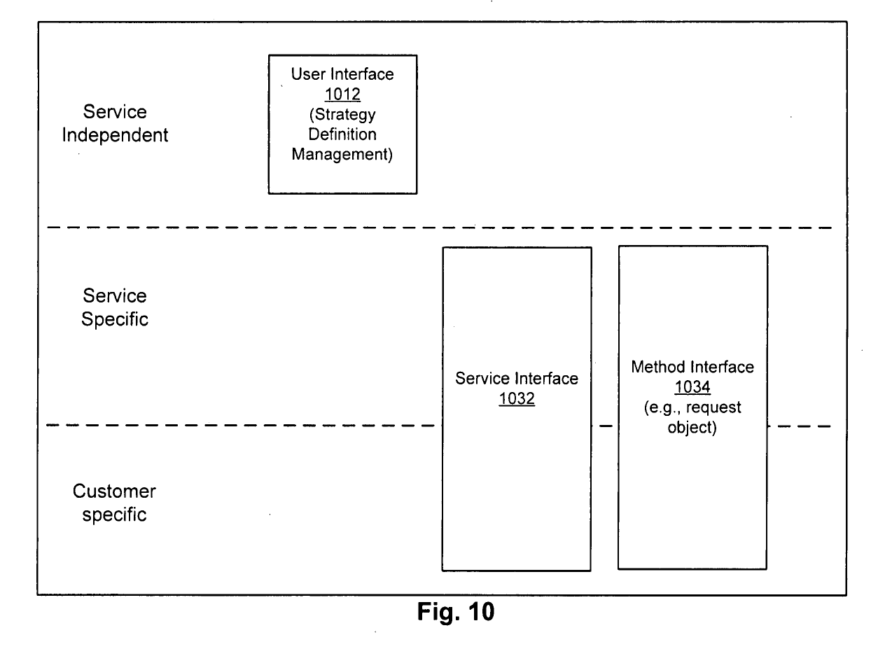

Referring to process block 920, one or more methods are selected for the strategy. In one embodiment, a user interface (e.g., user interface 1012, shown in FIG. 10) provides access to one or more methods in a method pool (e.g., method pool 410, shown in FIG. 4). In such an embodiment, selecting methods for the strategy includes receiving user selections from the user interface that select one or more methods from the method pool.

Referring to process block 930, the selected method(s) are assigned to the strategy. In one embodiment, assigning the methods includes assigning the methods to a strategy method database (e.g., strategy method database 214, shown in FIG. 2) or other logical structure associated with the strategy. In an embodiment, the order in which the methods are to be executed is also assigned based, at least in part, on a user selection from the user interface. The strategy is saved to a memory (e.g., memory 430, shown in FIG. 4) at 940. The process may be repeated to define another strategy at 945.

FIG. 9B is a flow diagram illustrating certain aspects of a process for a service controller, according to an embodiment of the invention. Referring to process block 950, the service controller may receive input describing a problem through a service interface (e.g., service interface 170, shown in FIG. 1). For example, the service controller may receive a collection of attributes (e.g., attributes 510, shown in FIG. 5) that, at least partly, describe a business problem such as route determination. Referring to process block 960, the service controller may create a service request (e.g., service request 140, shown in FIG. 1) based, at least in part, on the received input. Creating a service request includes, for example, instantiating a service request object from a service request class (e.g., service request class 844, shown in FIG. 8).

Referring to process block 970, the service controller determines a strategy for the service request. The phrase “determining a strategy” broadly refers to selecting a defined strategy to process the service request. In one embodiment, the strategy can be determined based, at least in part, on the requirements of a problem description provided in the service request. In such an embodiment, the service controller has the flexibility to determine the best available strategy to process the service request. For example, the service controller may apply strategy determination logic (e.g., strategy determination logic 520, shown in FIG. 5) to determine the strategy for the service request based, at least in part, on attributes provided in the service request. Alternatively, the strategy may be determined based, at least in part, on user input specifying a strategy that is provided through the service interface (e.g., service interface 170, shown in FIG. 1).

Referring to process block 980, the strategy may be executed based, at least in part, on the service request. For example, the service controller may pass the service request to each method of the strategy. In one embodiment, each method of the strategy is anonymously executed. The term “anonymously executed” indicates that the service controller calls the methods without knowing which methods are actually invoked. In an embodiment, each method implements the same interface to facilitate anonymous method execution.

In an embodiment, the strategy definition management logic can define parameters and methods as well as strategies. In such an embodiment, the functionality of a strategy may be extended (or altered) based on new method(s) and/or new parameter(s). The new method may be based, at least in part, on a method type in a method database (e.g., method database 208, shown in FIG. 2). Similarly, the new parameter may be based, at least in part, on a parameter type in a parameter database (e.g., parameter database 206, shown in FIG. 2). In an embodiment, the new parameter may be added to a method of the strategy and/or the new method may be added to the strategy.

Elements of embodiments of the present invention may also be provided as a machine-readable medium for storing the machine-executable instructions. The machine-readable medium may include, but is not limited to, flash memory, optical disks, compact disks-read only memory (CD-ROM), digital versatile/video disks (DVD) ROM, random access memory (RAM), erasable programmable read-only memory (EPROM), electrically erasable programmable read-only memory (EEPROM), magnetic or optical cards, propagation media or other type of machine-readable media suitable for storing electronic instructions. For example, embodiments of the invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

FIG. 10 is a block diagram illustrating various interfaces according to an embodiment of the invention. In an embodiment, some interfaces are service independent and other interfaces are service dependent. A service independent interface refers to an interface to access data and structures that are service independent such as the databases shown in FIG. 2. A service dependent interface refers to an interface that accesses service specific data and structures such as service interface 170, shown in FIG. 1.

In one embodiment, user interface 1012 provides a service independent interface to manage the definition of one or more strategies. User interface 1012 may be a graphical user interface, a command line driven interface, and the like. The management of strategies includes, for example, defining parameters, methods, strategies, and the like.

Service interface 1032 is an input/output (I/O) interface to a service controller. Service interface 1032 may be, for example, a simple I/O interface. Method interface 1034 represents the common interface shared among the methods of a service. In an embodiment, method interface 1034 includes a set of requests and a set of values to overwrite one or more standard values of one or more corresponding method parameters.

It should be appreciated that reference throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention.

Similarly, it should be appreciated that in the foregoing description of embodiments of the invention, various features are sometimes grouped together in a single embodiment, figure, or description thereof for the purpose of streamlining the disclosure aiding in the understanding of one or more of the various inventive aspects. This method of disclosure, however, is not to be interpreted as reflecting an intention that the claimed subject matter requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

What is claimed is:

1. A method for a cross-application process controller comprising:
defining a strategy, wherein the strategy is a sequence of methods provided by the cross-application process controller;
defining a request for a strategy based, at least in part, on an input; and
responding to the request, at least in part, by executing the strategy.

2. The method of claim 1, further comprising:
defining a method with the cross-application process controller.

3. The method of claim 2, wherein defining the method with the cross-application process controller comprises:
selecting a method type provided by the cross-application process controller;
saving the method in a method database of the cross-application process controller; and
saving the method and one or more associated parameters in a method parameter database of the cross-application process controller.

4. The method of claim 2, wherein each method has a common interface.

5. The method of claim 2, wherein defining the method comprises one or more of:
referring to a member of an application class; and
receiving user input defining the method.

6. The method of claim 1, further comprising:
defining a parameter with the cross-application process controller.

7. The method of claim 6, wherein defining a parameter with the cross-application process controller comprises:
selecting a parameter type provided by the cross-application process controller; and
saving the parameter in a parameter database of the cross-application process controller.

8. The method of claim 6, wherein defining a method with the cross-application process controller comprises:
associating zero, one, or a plurality of parameters of the cross-application process controller with the method to alter the function of the method.

9. The method of claim 8, wherein the common interface comprises:
a set of requests; and
a set of values to overwrite one or more standard values of one or more corresponding method parameters.

10. The method of claim 9, wherein responding to the request, at least in part, by executing the strategy comprises:
passing the request as an element of the set of requests to each method of the strategy.

11. The method of claims 1, wherein the request comprises at least part of a problem statement.

12. The method of claim 11, wherein responding to the request, at least in part, by executing the strategy comprises:
creating, at least in part, a problem solution corresponding to the problem statement.

13. The method of claim 12, further comprising:
saving at least part of the problem solution in the request.

14. The method of claim 1, wherein defining the request for a strategy comprises:
selecting the strategy to respond to the request based, at least in part, on the input.

15. The method of claim 1, wherein responding to the request, at least in part, by executing the strategy.
responding to the request, at least in part, by executing each method of the strategy anonymously in a specified order.

16. The method of claim 1, wherein defining the strategy comprises:
selecting a method from a method pool of the cross-application process controller, the method pool including a plurality of methods from a method database;
adding the method to the strategy;
selecting a standard value for a parameter of the method based, at least in part, on a parameter type of the parameter;
specifying an order for the one or more methods of the strategy; and
saving the strategy in a strategy database of the cross-application process controller.

17. The method of claim 16, further comprising:
saving the parameter and the standard value in a strategy method parameter database of the cross-application process controller.

18. A method comprising:
selecting a method from a method pool of a cross-application process controller, the method pool including a plurality of methods from a method database;
adding the method to a strategy;
specifying an order for one or more methods of the strategy; and
saving the strategy in a strategy database of the cross-application process controller.

19. The method of claim 18, further comprising:
defining a method with the cross-application process controller.

20. The method of claim 18, further comprising:
defining a parameter with the cross-application process controller.

21. The method of claim 20, further comprising:
selecting a standard value for a parameter of the method based, at least in part, on a parameter type of the parameter; and
saving the parameter and the standard value in a strategy method parameter database of the cross-application process controller.

22. A method comprising:
receiving an input through an interface;
creating a service request based, at least in part, on the input; and
executing a strategy based, at least in part, on the service request, wherein the strategy includes one or more methods.

23. The method of claim 22, wherein receiving the input through the interface comprises one or more of:
receiving user input from a graphical user interface; and
receiving input from a calling system.

24. The method of claim 22, wherein executing the strategy based, at least in part, on the service request, wherein the strategy includes one or more methods comprises:
executing each method of the strategy anonymously in a specified order.

25. A system comprising:
means for defining a strategy, wherein the strategy is a sequence of methods provided by the cross-application process controller;
means for defining a request for a strategy based, at least in part, on an input; and
means for responding to the request, at least in part, by executing the strategy.

26. The system of claim 25, wherein the means for defining a strategy, wherein the strategy is a sequence of methods provided by the cross-application process controller comprises:
means for selecting a method from a method pool of the cross-application process controller, the method pool including a plurality of methods from a method database;
means for adding the method to the strategy;
means for specifying an order for the sequence of methods of the strategy; and
means for saving the strategy in a strategy database of the cross-application process controller.

27. The system of claim 25, wherein the means for defining the request for a strategy comprises:
means for selecting the strategy to respond to the request based, at least in part, on the input.

28. The system of claim 25, wherein the means for responding to the request, at least in part, by executing the strategy comprises:
means for responding to the request, at least in part, by executing each method of the strategy anonymously in a specified order.

29. The system of claim 25, further comprising:
means for defining a method with the cross-application process controller.

30. An article of manufacture comprising an electronically accessible medium providing instructions that, when executed by an apparatus, cause the apparatus to:
define a strategy, wherein the strategy is a sequence of methods provided by the cross-application process controller;
define a request for a strategy based, at least in part, on an input; and
respond to the request, at least in part, by executing the strategy.

31. The article of manufacture of claim 30, wherein the instructions that, when executed by the apparatus, cause the apparatus to define the strategy cause the apparatus to:
select a method from a method pool of the cross-application process controller, the method pool including a plurality of methods from a method database;
add the method to the strategy;
specify an order for the sequence of methods of the strategy; and
save the strategy in a strategy database of the cross-application process controller.

32. The article of manufacture of claim 30, wherein the instructions that, when executed by the apparatus, cause the apparatus to define the request cause the apparatus to:
select the strategy to respond to the request based, at least in part, on the input.

33. The article of manufacture of claim 30, wherein the instructions that, when executed by the apparatus, cause the apparatus to respond to the request, at least in part, by executing the strategy cause the apparatus to:
respond to the request, at least in part, by executing each method of the strategy anonymously in a specified order.

34. The article of manufacture of claim 30, wherein the electronically accessible medium provides further instructions that, when executed by the apparatus, cause the apparatus to:
define a method with the cross-application process controller.

35. A graphical user interface for interacting with a cross-application process controller comprising:
a method pool having one or more methods selectable via a cursor control device, each of the one or more methods representing a method of the cross-application process controller; and
a strategy to specify a process flow wherein, upon selecting one of the one or more methods in the method pool, the method is assigned to the strategy.

36. The graphical user interface of claim 35, wherein the method pool is displayed in a first window of the graphical user interface.

37. The graphical user interface of claim 36, wherein the strategy is displayed in a second window of the graphical user interface.

38. The graphical user interface of claim 35, wherein the method pool displays information related to each of the one or more methods.

39. The graphical user interface of claim 38, when the displayed information includes one or more of:
a method name; and
a method description.

40. The graphical user interface of claim 35, wherein as the cursor control device drags one of the one or more methods of the method pool to the strategy, the method is assigned to the strategy.

41. The graphical user interface of claim 35, wherein as the cursor control device places a method of the method pool into the strategy, an order of execution is assigned to the method based, at least in part, on a placement of the method within the strategy.

42. The graphical user interface of claim 35, further comprising:
one or more parameter types selectable via the cursor control device, wherein a parameter is defined responsive, at least in part, to selecting one of the one or more parameter types with the cursor control device.

43. The graphical user interface of claim 42, further comprising:
one or more parameters selectable via the cursor control device to specify a behavior of a method wherein, upon selecting one of the one or more parameters, the parameter is assigned to the method.

44. The graphical user interface of claim 43, further comprising:
one or more standard values for each parameter, each of the one ore standard values selectable via the cursor control device wherein, upon selecting one of the one or more values, the value is assigned to an associated parameter.
